(19) United States
(12) Patent Application Publication
(10) Pub. No.: US 2015/0266172 A1
(43) Pub. Date: Sep. 24, 2015

(54) WRENCH AND COATING METHOD THEREOF

(71) Applicants: YU-CHING KUO, Taichung City (TW); YI-CHING YU, Taichung City (TW)

(72) Inventors: YU-CHING KUO, Taichung City (TW); YI-CHING YU, Taichung City (TW)

(21) Appl. No.: 14/257,897

(22) Filed: Apr. 21, 2014

(30) Foreign Application Priority Data
Mar. 20, 2014 (TW) 103110568

(51) Int. Cl. B25B 23/00; B05D 3/12; B05D 3/04; B25B 13/46; B05D 1/18

(52) U.S. Cl. CPC B25B 23/00; B25B 13/46; B05D 1/18; B05D 3/0406; B05D 3/12

(57) ABSTRACT

At least one embodiment in accordance with the present invention provides a wrench comprising a wrench head, a button configured to the wrench, a protective layer configured on the button, a rod-like body connected to the wrench head, and a handle connected to the rod-like body. At least one embodiment in accordance with the present invention provides a coating method for coating a protective layer on a button of a wrench.

### BACKGROUND OF THE INVENTION

1. Technical Field

At least one embodiment in accordance with the present invention provides a wrench and the coating method thereof. More particularly, at least one embodiment provides a wrench and a coating method for coating a protective layer on a button of the wrench.

2. Description of the Related Art

A wrench is configured to tighten or loosen fasteners with rotations. After being invented for years, several deficiencies in conventional wrenches have been overcome; one among these deficiencies is the heavy load of carrying numerous wrenches in different types and sizes. Ratchet wrenches are therefore invented to reduce this deficiency. A ratchet wrench comprises a handle, a rod-like body, a wrench head, and a socket set containing several sockets in different sizes and types. However, ratchet wrenches come with inconvenience not existing in conventional wrenches. For example, a user using a ratchet wrench may spend a lot of time on frequently releasing and locking the sockets.

Some ratchet wrenches are featured with quick release buttons and aimed to improve the efficiency of socket-changing procedure; these buttons can release or lock the socket in seconds. These buttons usually decorated with unique identifiers (e.g. word, alphabet, number, or symbol) to informed users the specification of the buttons. Nevertheless, identifiers printed or carved on the button are rusted or faded away easily after rubbing repeatedly and lead to difficulties in recognizing these identifiers.

### SUMMARY

At least one embodiment in accordance with the present invention provides a wrench comprising a wrench head, a button configured on the wrench head, a protective layer configured on the button, a rod-like body connected to the wrench head, and a handle connected to the rod-like body.

In some embodiments, the button comprises a cap, wherein the cap is in a circular shape, an elliptical shape, or a polygonal shape; an identifier is on the button, wherein the identifier is one selected from the group consisting of a word, a number, a pattern, a symbol, and the combination thereof; a protective layer covered on the button, wherein the protective layer is transparent and is bulging at the center of the identifier, and therefore able to enlarge the identifier as a magnifying glass; the protective layer is made of one selected from the group consisting of bicyclic terpene and monocyclic terpene, or is made of diethylhexyl adipate and one selected from the group consisting of polyethylene, polyvinylchloride, polymethylmethacrylate, polycarbonate, polystyrene, and acrylonitrile butadiene styrene.

In some other embodiments, the protective layer covered on the button is transparent or translucent; therefore, the identifiers under the protective layer are visible. Moreover, the plasticizer, diethylhexyl adipate, also plays a role as a rust inhibitor which avoids rusting of the button. After the button was applied with the protective layer, the button is then place onto a wrench head of a wrench.

At least one embodiment in accordance with the present invention provides a coating method comprising: preparing an amorphous resin, wherein the amorphous resin is a natural resin like bicyclic terpene or monocyclic terpene, or a synthetic resin like polyethylene, polyvinylchloride, polymethylmethacrylate, polycarbonate, polystyrene, or acrylonitrile butadiene styrene; hanging the button upside down, and then dipping the cap of the button into the amorphous resin; moving the button out of the amorphous resin and hanging the button upside down in the air, wherein part of the resin remaining on the button accumulates at the cap of the button due to the cohesive force and gravity; drying the resin at 25-80° C. for 10˜60 minutes to form a protective layer; and, configuring the button to a wrench head of a wrench.

At least one embodiment of the present invention provides a wrench and a coating method for coating a protective layer on the button of a wrench; the protective layer provides the wrench the strength to overcome some problems found in conventional wrenches; for example, the identifiers printed or carved on the button may rust or fade away easily after rubbing repeatedly.

### BRIEF DESCRIPTION OF THE DRAWINGS

FIG. 1 is a perspective view illustrating a combined wrench in accordance with at least one embodiment of the present invention.

FIG. 2 is a perspective view illustrating an uncombined wrench in accordance with at least one embodiment of the present invention.

FIG. 3 is a flow diagram representing a coating method in accordance with at least one embodiment of the present invention.

### DESCRIPTION OF THE PREFERRED EMBODIMENTS

In a general aspect, at least one embodiment in accordance with the present invention provides a wrench and the coating method thereof. More particularly, at least one embodiment provides a wrench and a coating method for coating a protective layer on a button of the wrench. The embodiments and drawings provided here show different aspects of the present invention. However, the present invention are neither limited to any embodiment nor drawing thereof

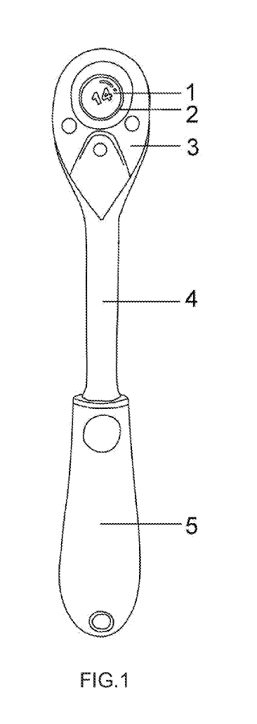

FIG. 1 is a perspective view illustrating a combined wrench in accordance with at least one embodiment of the present invention; in this figure, the wrench and the button are combined together. In some aspects of FIG. 1, a wrench is provided for tightening or loosening fasteners, such as nuts or bolts, with rotations; the wrench is configured to drive a socket carried by the wrench and a fastener in accordance with the socket; wherein the socket is interchangeable with another socket in different size and type.

In some other aspects of FIG. 1, a wrench comprises: a wrench head 3 for adapting a socket, wherein the wrench head 3 further containing a button 1; a rod-like body 4 connected to the wrench head 3; and, a handle 5 connected to the rod-like body 4. In yet some other aspects of FIG. 1, the button 1 comprises a cap, wherein the cap is in a circular shape, an elliptical shape, or a polygonal shape; an identifier is on the button 1, wherein the identifier is one selected from the group consisting of a word, a number, a pattern, a symbol, and the combination thereof; a protective layer 2 configured on the button 1, wherein the protective layer 2 is transparent or translucent. In still yet some other aspects of FIG. 1, the protective layer 2 is made of polyvinylchloride and diethylhexyl adipate; therefore, the protective layer 2 is soft, transparent, resilient, and adhesive; the protective layer 2 is able to protect the identifiers on the button 1 from rusting or rubbing; and, the protective layer 2 is also able to increase the friction of the button 1 and therefore increases the stability when holding the button 1.

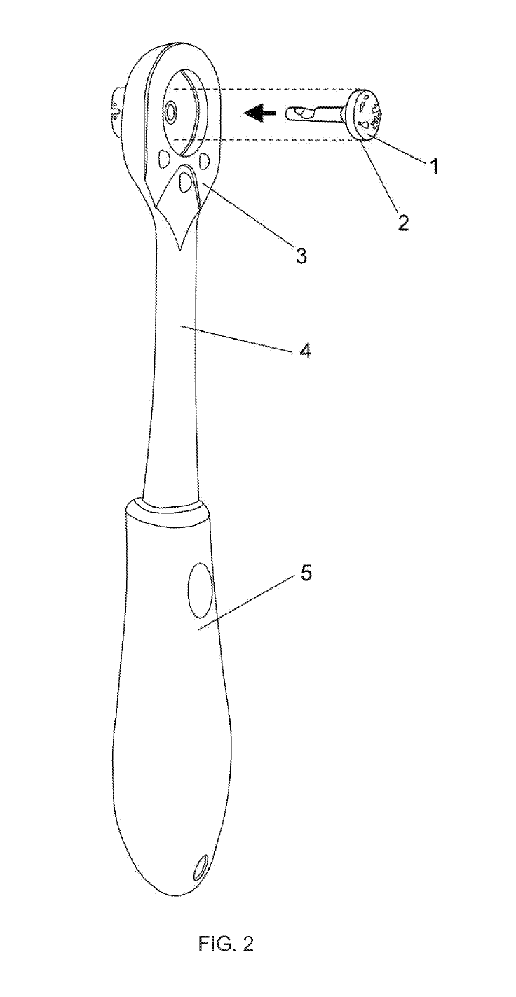

FIG. 2 is a perspective view illustrating an uncombined wrench in accordance with at least one embodiment of the present invention; in this figure, the wrench and the button are shown separately. In some aspects of FIG. 2, a button 1 is adapted to be inserted to one side of a wrench head 3, and the opposite side of the wrench head 3 is for adapting a socket. In some other aspects of FIG. 2, the button 1 is configured for quick release of the socket, and therefore the socket is able to change to another socket with ease.

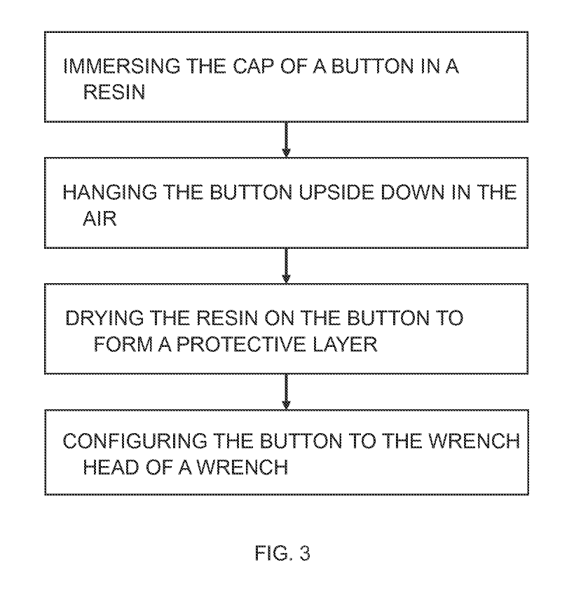

FIG. 3 is a flow diagram representing a coating method in accordance with at least one embodiment of the present invention. In some aspect of FIG. 3, the coating method comprises: immersing a cap of a button 1 in a natural resin or a synthetic resin; hanging the button 1 upside down in the air; drying the natural resin or the synthetic resin on the button 1 to form a protective layer 2; and, configuring the button 1 to a wrench head 3 of a wrench. In some other aspects of FIG. 3, the natural resin is one selected from the group consisting of bicyclic terpene and monocyclic terpene; the synthetic resin is made of a plasticizer and one selected from the group consisting of polyethylene, polyvinylchloride, polymethylmethacrylate, polycarbonate, polystyrene, and acrylonitrile butadiene styrene, wherein the plasticizer is diethylhexyl adipate. In yet some other aspects of FIG. 3, the button 1 is hanging with a rope, a hook, or a robot arm; therefore, part of the amorphous resin accumulates at the downside of the button 1 due to gravity and forming a bulge due to the cohesive force. In still yet some aspects of FIG. 3, the amorphous resin is drying at 25-80° C. for 10˜60 minutes to form a protective layer 2.

At least one embodiment of the present invention provides a wrench and a coating method for coating a protective layer on the button of a wrench; the protective layer provides the wrench the strength to overcome some problems found in conventional wrenches; for example, the identifiers printed or carved on the button may rust or fade away easily after rubbing repeatedly.

What is claimed is:

1. A wrench, comprising:
a wrench head containing a button;
a protective layer configured on the button, wherein the protective layer is transparent;
a rod-like body connected to the wrench head; and
a handle connected to the rod-like body.

2. The wrench according to claim 1, wherein the button comprises a cap, and wherein the cap is in a circular shape, an elliptical shape, or a polygonal shape.

3. The wrench according to claim 1, wherein an identifier is on the button, and wherein the identifier is one selected from the group consisting of a word, a number, a pattern, a symbol, and the combination thereof

4. The wrench according to claim 1, wherein the protective layer is made of one selected from the group consisting of bicyclic terpene and monocyclic terpene, or is made of a plasticizer and one selected from the group consisting of polyethylene, polyvinylchloride, polymethylmethacrylate, polycarbonate, polystyrene, and acrylonitrile butadiene styrene.

5. The wrench according to claim 4, wherein the plasticizer is diethylhexyl adipate.

6. A coating method, comprising:
immersing a cap of a button in a natural resin or a synthetic resin;
hanging the button upside down in the air;
drying the natural resin or the synthetic resin on the button to form a protective layer; and
configuring the button to a wrench head of a wrench.

7. The coating method according to claim 6, wherein the natural resin is one selected from the group consisting of bicyclic terpene and monocyclic terpene.

8. The coating method according to claim 6, wherein the synthetic resin is made of a plasticizer and one selected from the group consisting of polyethylene, polyvinylchloride, polymethylmethacrylate, polycarbonate, polystyrene, and acrylonitrile butadiene styrene.

9. The coating method according to claim 8, wherein the plasticizer is diethylhexyl adipate.

10. The coating method according to claim 6, wherein the button is hanging with a rope, a hook, or a robot arm.

11. The coating method according to claim 6, wherein the natural resin or the synthetic resin is dried for a time ranging from 10 minutes to 60 minutes.

12. The coating method according to claim 6, wherein the natural resin or the synthetic resin is dried at a temperature ranging from 25° C. to 80° C.
